(19) United States
(12) Patent Application Publication
(10) Pub. No.: US 2026/0182794 A1
(43) Pub. Date: Jul. 2, 2026

(54) VACUUM CLEANER BASE STATION

(71) Applicant: Suzhou Ch'In-Hoo Cleaning Equipment Co., LTD, Jiangsu (CN)

(72) Inventors: Zhuang Bian, Jiangsu (CN); Yuyuan Huang, Jiangsu (CN)

(73) Assignee: Suzhou Ch'In-Hoo Cleaning Equipment Co., LTD, Jiangsu (CN)

(21) Appl. No.: 19/150,035

(22) PCT Filed: Nov. 16, 2023
(86) PCT No.: PCT/CN2023/132011

§ 371 Date: Feb. 5, 2026

(30) Foreign Application Priority Data
Nov. 25, 2022 (CN) 202223136907.X
Jul. 21, 2023 (CN) 202321930161.1

(51) Int. Cl. A47L 9/00; A47L 7/00; A47L 9/12; A47L 9/14; A47L 9/28; E05D 15/06

(52) U.S. Cl. CPC A47L 9/0063; A47L 7/0061; A47L 9/12; A47L 9/1481; A47L 9/149; A47L 9/2884; E05D 15/0621

(57) ABSTRACT

A vacuum cleaner base station (100), suitable for a portable vacuum cleaner (200) to dock. The vacuum cleaner base station (100) comprises: a housing (11), a docking seat (12), a dust collection bag (13), a vacuum motor (14), and a sliding door (15), the sliding door (15) being located at the rear portion (118) of the housing (11) and being configured to be opened by sliding laterally outward. An inner side of the sliding door (15) defines a receiving space (151) configured to receive at least a portion of a plurality of vacuum head attachments (241, 242, 243) attached to the portable vacuum cleaner (200).

### FIELD OF THE INVENTION

The present application relates to a vacuum cleaner base station, and in particular to a vacuum cleaner base station for transferring dust in a portable vacuum cleaner to the interior of the base station.

### BACKGROUND

Portable vacuum cleaners are common household manual cleaning devices. Debris and other garbage are sucked in by the floor brush or vacuum head of the portable vacuum cleaner and gathered in the dust cup of the vacuum cleaner. Due to the portable nature of the vacuum cleaner, the volume of the dust cup is usually set small, and users need to frequently manually clean the garbage in the dust cup.

In order to improve the convenience of using such portable vacuum cleaners, a base station is often configured for the portable vacuum cleaners, which can be used to dock the unused portable vacuum cleaners and transfer the garbage in the portable vacuum cleaners. After the portable vacuum cleaner is docked with the base station, the garbage in the dust cup of the portable vacuum cleaner can be automatically transferred to the dust storage component in the base station; since the base station does not need to be frequently carried or moved, it can be equipped with a dust storage component of relatively large capacity (such as a dust collection bag), which may be several times or even dozens of times larger in volume than a dust cup; after the garbage in the dust storage component is full, the garbage in the dust storage component can be cleaned up at once, or a new dust storage component can be directly replaced; it can greatly facilitate users to use portable vacuum cleaners.

Since different vacuum head attachments are required for different usage scenarios of portable vacuum cleaners, portable vacuum cleaners are often equipped with a variety of different replaceable vacuum head attachments; and the storage of vacuum head attachments is also an urgent problem to be solved. The publication numbers KR1220124376, CN111463840A, and CN21582771U all disclose the use of the receiving space formed within the base station itself to store vacuum head attachments. These solutions help prevent the loss of the attachments. However, in these public solutions, there are generally problems such as it is inconvenient for users to take out and return the vacuum head attachments, and the base station is not compact enough.

### SUMMARY

In order to improve the storage problem of the vacuum head attachments of the portable vacuum cleaner in the prior art mentioned above, the present application provides a vacuum cleaner base station which can facilitate users to empty the dust bucket of the portable vacuum cleaner.

The present application provides a vacuum cleaner base station, which is suitable for docking a portable vacuum cleaner, wherein the portable vacuum cleaner comprises a portable vacuum cleaner body, a vacuum wand, a floor brush and a plurality of vacuum head attachments, wherein the portable vacuum cleaner body comprises a dust cup, a dust cup bottom cover which can be switched between an open position and a closed position, a vacuum motor and a rechargeable battery pack; the base station comprises: a housing, which can be supported on a horizontal plane and comprises a front wall, a first side wall and a second side wall which are opposite to each other, wherein the interior of the housing has a cavity; a docking seat, which is located at the upper part of the housing and is configured to hold at least a portion of the portable vacuum cleaner body, wherein the at least one portion including the dust cup bottom cover; the docking seat comprises a docking opening that is fluidly connected to the dust cup when the dust cup bottom cover is in the open position, and the docking opening is fluidly connected to the cavity; a dust collection bag, removably arranged in the cavity; a suction motor, for generating an airflow from the docking opening to the dust collection bag; and a sliding door, located at the rear portion of the housing and configured to be opened by sliding laterally outward, wherein an inner side of the sliding door defines a receiving space configured to receive at least a portion of the plurality of vacuum head attachments.

The advantage of the above solution is that the vacuum head attachments are received in the receiving space formed on the inner side of the sliding door, which allows the operator to store and take the vacuum head attachments in a particularly simple manner.

In some specific embodiments, the sliding door comprises a bracket located in the receiving space, and the bracket is configured to support the vacuum head attachments when the vacuum head attachments are located in the receiving space. This solution enables the vacuum head attachments to be stably received inside the sliding door.

In some specific embodiments, the sliding door comprises a rear wall, a first extension wall extending forward from a side edge of the rear wall, and a second extension wall extending forward from another side edge of the rear wall, and the rear wall, the first extension wall and the second extension wall define the receiving space.

In some specific embodiments, the first extension wall and/or the rear wall are provided with handles for the user to grasp.

In some specific embodiments, when the sliding door is closed, the first side wall is butted against the first extension wall front to back, and the second side wall is butted against the second extension wall front to back.

In some specific embodiments, the sliding door has a U-shaped transverse cross-section.

In some specific embodiments, the rear portion of the housing has a recessed portion; when the sliding door is closed, the sliding door covers the recessed portion.

In some specific embodiments, at least one set of sliding mechanisms is arranged between the sliding door and the rear portion of the housing, and each of the sliding mechanisms comprises a sliding rail arranged on a component between the sliding door and the rear portion of the housing and at least one roller arranged on another component between the sliding door and the rear portion of the housing, and the at least one roller can slide along the sliding rail.

In some specific embodiments, the slide rail is a two-section slide rail or a three-section slide rail.

In some specific embodiments, two sliding mechanisms are provided between the sliding door and the rear portion of the housing, and the two sliding mechanisms are arranged one above and one below.

In some specific embodiments, the vacuum cleaner base station further comprises a spare battery pack storage compartment, which is arranged on the upper portion of the housing and located at the rear side of the docking seat.

In some specific embodiments, the spare battery pack storage compartment has an upper opening, and a lift-up cover is provided at the upper opening.

In some specific embodiments, the bottom of the housing has a base, and the front part of the base protrudes forward relative to the front wall.

In some specific embodiments, the front wall comprises an openable and closable front door, and the dust collection bag is configured to be removable from the cavity when the front door is opened.

In some specific embodiments, the portable vacuum cleaner body has a locking assembly for limiting the dust cup bottom cover in the closed position, and the locking assembly comprises an operable unlocking component; the vacuum cleaner base station further comprises: an opening mechanism, which is used to trigger the unlocking component when the portable vacuum cleaner body is docked with the docking seat, so that the dust cup bottom cover in the closed position is converted to the open position; and a closing mechanism, which is used to push the dust cup bottom cover in the open position into the closed position when the portable vacuum cleaner body is docked with the docking seat.

In some specific embodiments, the opening mechanism comprises a first motor and a first transmission mechanism, the first transmission mechanism comprises a gear that can be driven to rotate by the output shaft of the first motor, a rack meshing with the gear, and a moving component arranged in transmission connection with the rack, the moving component has an inclined surface inclined relative to a horizontal plane; when the portable vacuum cleaner body is docked with the docking seat, the inclined surface faces the unlocking component.

In some specific embodiments, the closing mechanism comprises a second motor and a second transmission mechanism. The second transmission mechanism comprises a push rod that can be driven by the output shaft of the second motor to move along a straight line, and the straight line and the horizontal plane form an angle greater than or equal to 10° and less than or equal to 80°; when the portable vacuum cleaner body is docked with the docking seat, the end of the push rod faces the dust cup bottom cover.

In some specific embodiments, the vacuum cleaner base station further comprises: a sterilization component, which is arranged in the cavity.

In some specific embodiments, the interior of the housing has a motor installation cavity located below the cavity, the suction motor is installed in the motor installation cavity, and the rear portion of the housing has exhaust ports connected to the motor installation cavity.

In some specific embodiments, the rear portion of the housing has a rear cover that can be operated to be opened and closed, the exhaust ports are arranged on the rear cover, and a motor downstream filter is arranged on the inner side of the rear cover.

### BRIEF DESCRIPTION OF THE DRAWINGS

In the drawings, like reference numerals typically refer to the same parts in different views. The drawings are not necessarily drawn to scale; instead, emphasis is generally placed on illustrating the principles of the present invention. In the following description, reference is made to the accompanying drawings, in which:

FIG. 1 is a side schematic view showing a portable vacuum cleaner docked on a vacuum cleaner base station according to an embodiment of the present application;

FIG. 2 is a front schematic view showing a portable vacuum cleaner docked on a vacuum cleaner base station according to an embodiment of the present application;

FIG. 3 is an exploded schematic view of a locking assembly of the portable vacuum cleaner body according to an embodiment of the present application;

FIG. 4 is a perspective schematic view of the vacuum cleaner base station with its sliding door pulled laterally outward according to an embodiment of the present application;

FIG. 5 is a rear schematic view of the vacuum cleaner base station with its sliding door pulled laterally outward according to an embodiment of the present application;

FIG. 6 is a perspective schematic view of the vacuum cleaner base station with the sliding door removed according to an embodiment of the present application;

FIG. 7 is a perspective schematic view showing several vacuum head attachments supported on the inner side of the sliding door according to an embodiment of the present application;

FIG. 8 is a side schematic view of the vacuum cleaner base station with all doors in an open state according to an embodiment of the present application;

FIG. 9 is a side cross-sectional schematic view of the vacuum cleaner base station according to an embodiment of the present application;

FIG. 10 is an enlarged schematic view of the dashed box A in FIG. 9;

FIG. 11 is a perspective schematic view of the vacuum cleaner base station with part of the housing removed according to an embodiment of the present application;

FIG. 12 is a partial cross-sectional schematic view showing the portable vacuum cleaner docked on the vacuum cleaner base station with the dust cup bottom cover in an open state according to an embodiment of the present application;

FIG. 13 is an enlarged schematic view of the dashed box B in FIG. 12;

FIG. 14 is a partial cross-sectional schematic view showing the portable vacuum cleaner docked on the vacuum cleaner base station with the dust cup bottom cover in a closed state according to an embodiment of the present application;

FIG. 15 is an enlarged schematic view of the dashed box C in FIG. 14.

### DESCRIPTION OF PREFERRED EMBODIMENTS

The embodiments described below with reference to the accompanying drawings are

exemplary and are provided merely to explain the present application, and should not be construed as limiting the application.

In the description of the present application, it should be understood that the terms “upper”, “lower”, “front”, “rear”, “left”, “right”, “horizontal”, “top”, “bottom”, “inside”, “outside” and the like, which indicate orientation or positional relationships, are based on the orientation or positional relationships shown in the drawings. These terms are used solely for the convenience of describing the application and simplifying the description, and are not intended to indicate or imply that the apparatus or components must have a particular orientation, be constructed, or operated in a particular orientation. Therefore, they should not be construed as limiting the application.

In the description of the present application, unless otherwise expressly specified and limited, the terms “mounted” and “connected” should be understood in a broad sense. For example, they may be fixedly connected or removably connected, or integrally connected; they may be mechanically connected or electrically connected; they may be directly connected or indirectly connected through an intermediate medium; or there may be communication between two components internally. For those skilled in the art, the specific meaning of the above terms in the present application can be understood according to the specific circumstances.

The vacuum cleaner base station 100 according to an embodiment of the present invention is described below with reference to the accompanying drawings.

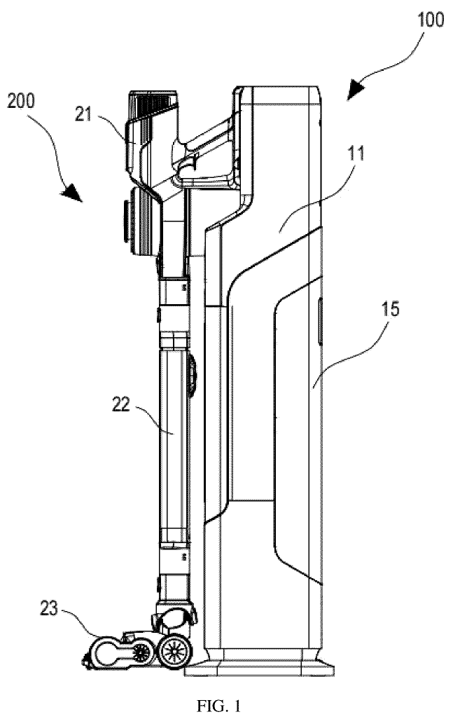

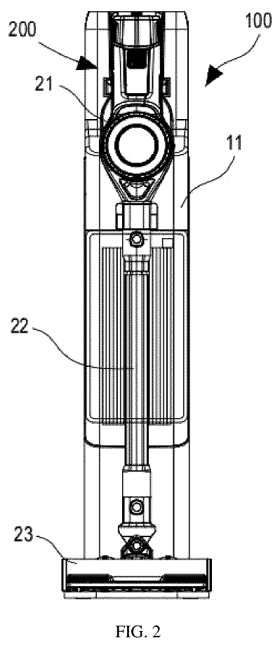

As shown in FIGS. 1 and 2, a vacuum cleaner base station 100 is provided according to an embodiment of the present invention, which is used in conjunction with a portable vacuum cleaner 200; specifically, the portable vacuum cleaner 200 can be docked on the vacuum cleaner base station 100 to achieve functions such as storage, charging, and dust removal.

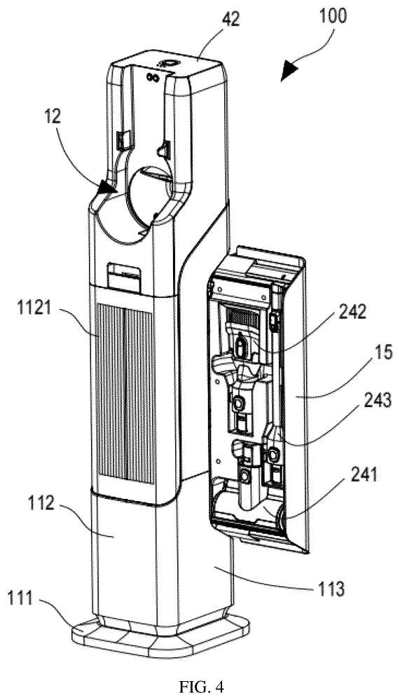

The portable vacuum cleaner 200 shown in FIGS. 1 and 2 is a typical portable vacuum cleaner type, which mainly comprises a portable vacuum cleaner body 21, a hard vacuum wand 22, a floor brush 23 and several vacuum head attachments. The vacuum head attachments (as shown in FIG. 4) include a mattress vacuum head 241, a brush vacuum head 242 and a crevice vacuum head 243. One end of the hard vacuum wand 22 is connected to the suction port of the portable vacuum cleaner body 21, and the other end can be connected to the floor brush 23 or any one of the vacuum heads of the several vacuum head attachments; each vacuum head of the several vacuum head attachments can also be directly connected to the suction port of the portable vacuum cleaner body 21 to clean the corresponding cleaning area under different circumstances.

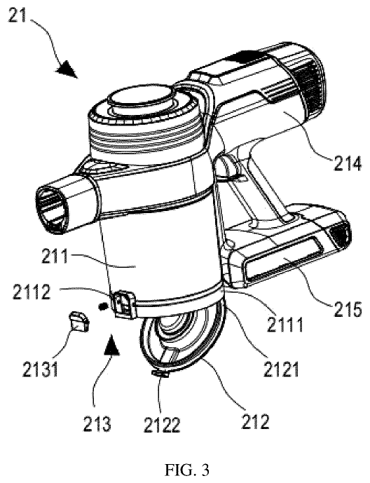

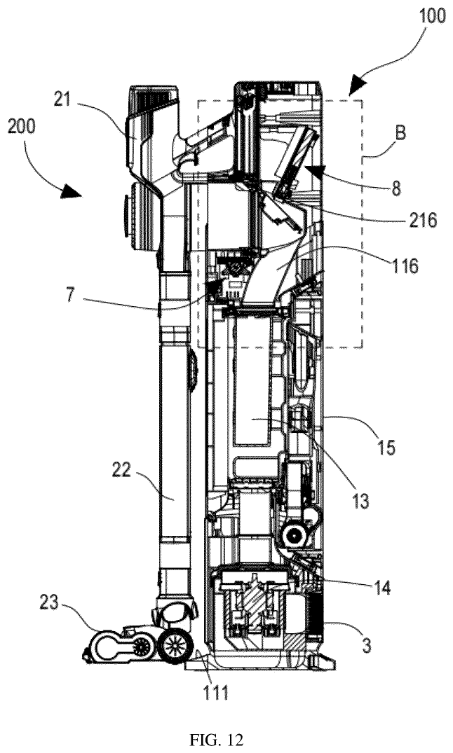

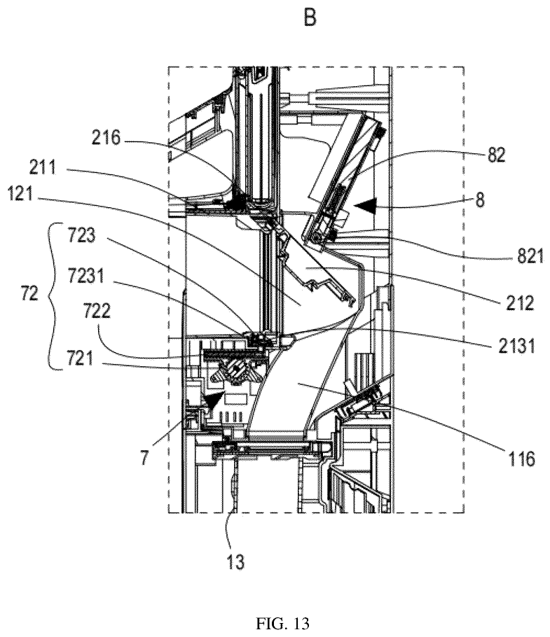

As shown in FIG. 3, the portable vacuum cleaner body 21 can be carried by a user in one hand and comprises a dust cup 211, a dust cup bottom cover 212 switchable between an open position and a closed position, a locking assembly 213 for limiting the dust cup bottom cover 212 in a closed position, a vacuum motor 214, and a rechargeable battery pack 215. The locking assembly 213 comprises an operable unlocking component 2131. One end 2121 of the dust cup bottom cover 212 is hinged to a side portion 2111 of the dust cup 211 and a torsion spring 216 is arranged between the two (see FIGS. 12 and 13), and the other end 2122 of the dust cup bottom cover 212 can be locked with the other side portion 2112 of the dust cup 211, and after the two are locked, they can be unlocked by triggering the unlocking component 2131, so that the other end 2122 of the dust cup bottom cover 212 is disengaged from the other side portion 2112 of the dust cup 211, so that dust can be removed from the dust cup 211.

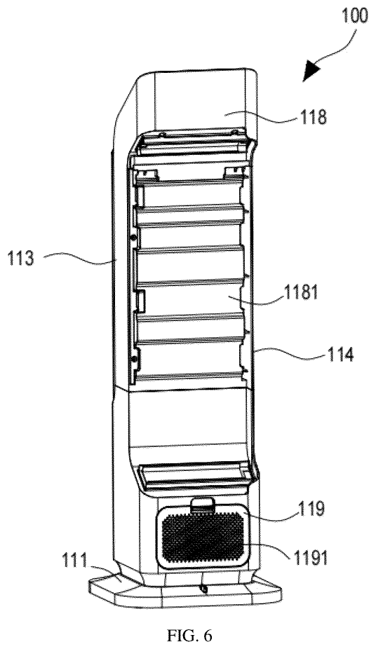

As shown in FIGS. 4, 5 and 6, the vacuum cleaner base station 100 can be supported on a plane, such as a flat ground. The vacuum cleaner base station 100 comprises a housing 11, a docking seat 12 located at the top of the housing 11, and a sliding door 15 located at the rear side of the housing 11.

The housing 11 is an upright square cylindrical component, and has a base 111 at its bottom. The housing 11 comprises a front wall 112, a first side wall 113 and a second side wall 114 opposite to each other, and the front part of the base 111 protrudes forward relative to the front wall 112. With the help of the base 111, the housing 11 can be supported on a horizontal plane. The interior of the housing 11 has a cavity 115, a channel 116 located above the cavity 115, and a motor installation cavity 117 located below the cavity 115. The rear portion 118 of the housing 11 has a recessed portion 1181.

The docking seat 12 is composed of a portion of the upper portion of the housing 11. The docking seat 12 is configured to dock a portion of a portable vacuum cleaner body 21, which comprises a portion of the dust cup 211 and the dust cup bottom cover 212. The docking seat 12 has a docking opening 121 for fluid communication with the dust cup 211 when the dust cup bottom cover 212 is in an open position. The docking opening 121 is fluidly connected to the cavity 115 through the channel 116.

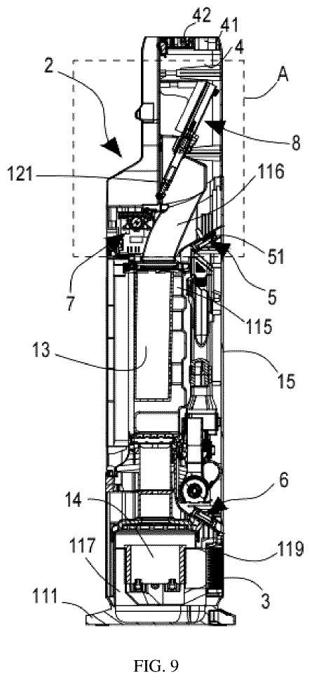

As shown in FIG. 9, the vacuum cleaner base station 100 further comprises a dust collection bag 13 and a suction motor 14 located inside the housing 11. The dust collection bag 13 is removably arranged in the cavity 115. The suction motor 14 is used to generate an airflow from the docking opening 121 to the dust collection bag 13. The suction motor 14 is installed in the motor installation cavity 117.

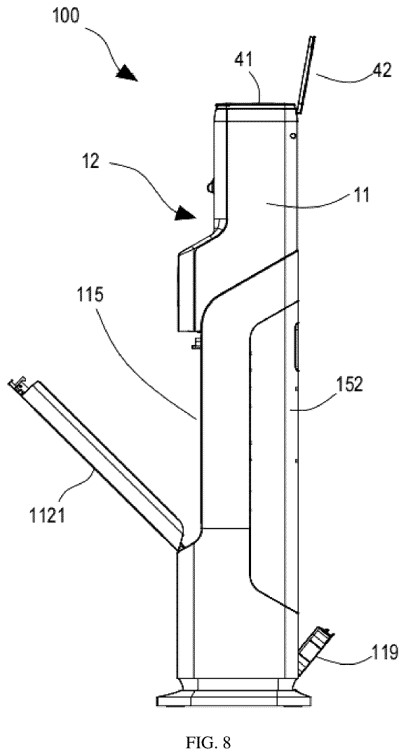

As shown in FIGS. 4 and 8, the front wall 112 comprises an openable and closable front door 1121, and the dust collection bag 13 is configured to be removable from the cavity 115 when the front door 1121 is opened; this makes it convenient for the user to clean the dust collection bag 13 or replace it with a new one.

To prevent bacterial growth at the dust collection bag 13, a sterilization component (not shown in the drawings) is further disposed within the cavity 115. The sterilization component may be, for example, an ultraviolet sterilization module, an ozone sterilization module, or the like.

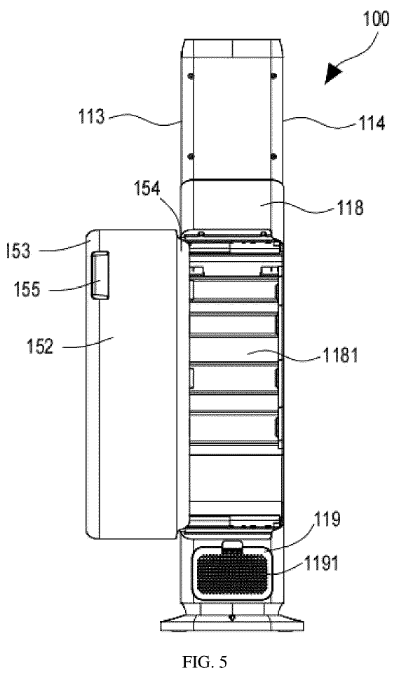

As shown in FIGS. 5, 6, 8 and 9, the rear portion of the housing 11 has a rear cover 119 that can be opened and closed, exhaust ports 1191 are arranged on the rear cover 119, and a motor downstream filter 3 is arranged on the inner side of the rear cover 119. By opening the rear cover 119, the motor downstream filter 3 can be cleaned of dust or replaced.

As shown in FIGS. 8 and 9, a spare battery pack storage compartment 4 is also provided at the upper portion of the housing 11, and the spare battery pack storage compartment 4 is also located at the rear side of the docking seat 12. The spare battery pack storage compartment 4 has an upper opening 41, and a lift-up cover 42 is provided at the upper opening 41. The spare battery pack storage compartment 4 can store a spare rechargeable battery pack 215, and the rechargeable battery pack 215 can be stored and charged in the compartment.

As shown in FIGS. 4 and 5, the sliding door 15 is located at the rear portion of the housing 11 and is configured to be opened by sliding laterally outward; when the sliding door 15 is closed, the sliding door 15 covers the recessed portion 1181 at the rear portion 118 of the housing 11.

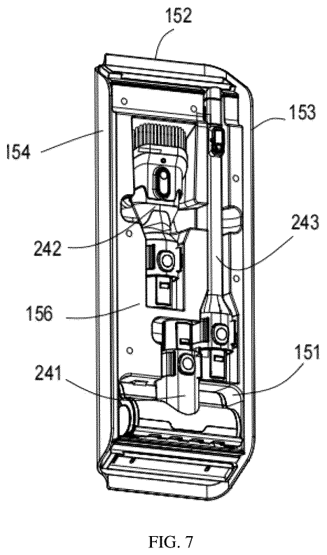

As shown in FIGS. 4 and 7, an inner side of the sliding door 15 defines a receiving space 151, and a bracket 156 is arranged in the receiving space 151. The receiving space 151 is configured to receive at least a portion of a plurality of vacuum head attachments; the bracket 156 is configured to support the vacuum head attachments when the vacuum head attachments are located in the receiving space 151. The plurality of vacuum head attachments illustrated in FIGS. 4 and 7 include a mattress vacuum head 241, a brush vacuum head 242, and a crevice vacuum head 243. When these vacuum heads are stored in the receiving space 151, they are all supported on the bracket 156.

The sliding door 15 has a U-shaped transverse cross-section; and the sliding door 15 comprises a rear wall 152, a first extension wall 153 extending forward from one side edge of the rear wall 152, and a second extension wall 154 extending forward from the other side edge of the rear wall 152. The rear wall 152, the first extension wall 153, and the second extension wall 154 define the receiving space 151.

When the sliding door 15 is closed, the first side wall 113 is butted against the first extension wall 153 front to back, and the second side wall 114 is butted against the second extension wall 154 front to back.

A handle 155 for the user to grasp is arranged on the first extension wall 153. In other embodiments, the handle may also be located at the rear wall of the sliding door, or at the junction of the rear wall and the extension wall.

As shown in FIG. 9, a pair of sliding mechanisms 5 and 6 arranged vertically are provided between the sliding door 15 and the rear portion 118 of the housing 11. Each sliding mechanism 5 or 6 comprises a slide rail (not shown in the figure) arranged on the sliding door 15 and at least one roller (not shown in the figure) arranged on the rear portion 118 of the housing 11, and the at least one roller can slide along the slide rail. The sliding mechanisms 5 and 6 can preferably be two-section slide rail mechanisms or three-section slide rail mechanisms.

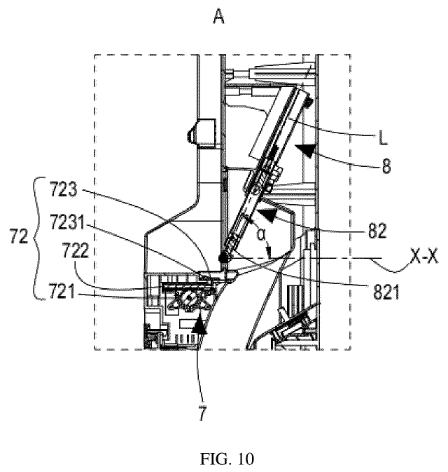

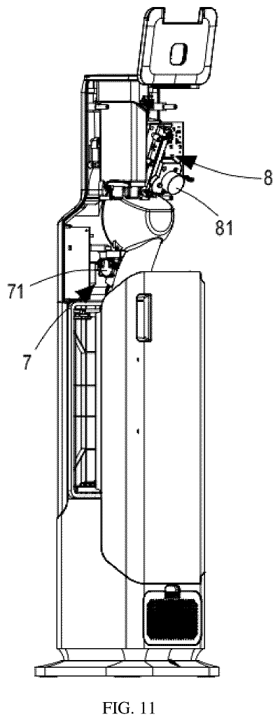

As shown in FIGS. 9, 10 and 11, the vacuum cleaner base station 1 further comprises an opening mechanism 7 and a closing mechanism 8. The opening mechanism 7 is used to trigger the unlocking component 2131 when the portable vacuum cleaner body 21 is docked with the docking seat 12, so that the dust cup bottom cover 212 in the closed position is switched to the open position. The closing mechanism 8 is used to push the dust cup bottom cover 212 in the open position to the closed position when the portable vacuum cleaner body 21 is docked with the docking seat 12.

The opening mechanism 7 comprises a first motor 71 and a first transmission mechanism 72. The first transmission mechanism 72 comprises a gear 721 that can be driven to rotate by the output shaft of the first motor 71, a rack 722 meshing with the gear 721, and a moving component 723 that is arranged in transmission connection with the rack 722. The moving component 723 has an inclined surface 7231 inclined relative to a horizontal plane. When the portable vacuum cleaner body 21 is docked with the docking seat 12, the inclined surface 7231 faces the unlocking component 2131; if the first motor 71 is started, the inclined surface 7231 can be driven by the first transmission mechanism 72 to apply a force to the unlocking component 2131, thereby triggering the unlocking component 2131 to release the dust cup bottom cover 212 from the closed position; or the inclined surface 7231 can be driven to move in a direction away from the unlocking component 2131.

The closing mechanism 8 comprises a second motor 81 and a second transmission mechanism 82. The second transmission mechanism 82 comprises a push rod 821 that can be driven by the output shaft of the second motor 81 to move along a straight line L, and the straight line L forms an angle α with the horizontal plane X-X that is greater than or equal to 10° and less than or equal to 80°. When the portable vacuum cleaner body 21 is docked with the docking seat 12, the end of the push rod 821 faces the dust cup bottom cover 212. If the second motor 81 is started, the push rod 821 can be driven by the second transmission mechanism 82 to apply a force to the dust cup bottom cover 212, so that the dust cup bottom cover 212 moves to the closed position; or the push rod 821 is driven to move in a direction away from the dust cup bottom cover 212.

Optionally, the opening mechanism 7 and the closing mechanism 8 are further provided with a plurality of detection components (not shown in the figure). The detection components of the opening mechanism 7 are used to detect the stroke of the moving component 723. After detecting that the moving component 723 moves to the set position, the first motor 71 is controlled to stop working and return to the original position under the guidance of the detection components. The detection components of the closing mechanism 8 are used to detect the stroke of the push rod 821. When the push rod 821 is detected to move to the set position, the second motor 81 is controlled to stop working and then return to the original position under the guidance of the detection components. These detection components can be used to accurately control the start and stop of the first motor and the second motor by cooperating with each other to prevent the moving component 723 and the push rod 821 from moving beyond the motion stroke, so that the opening mechanism 7 and the closing mechanism 8 can work accurately. The detection components can be micro switches, photoelectric switches, etc., with sensitive detection and convenient control. Of course, the types of detection components are not limited to these, and can also be other detection elements, which will not be repeated here.

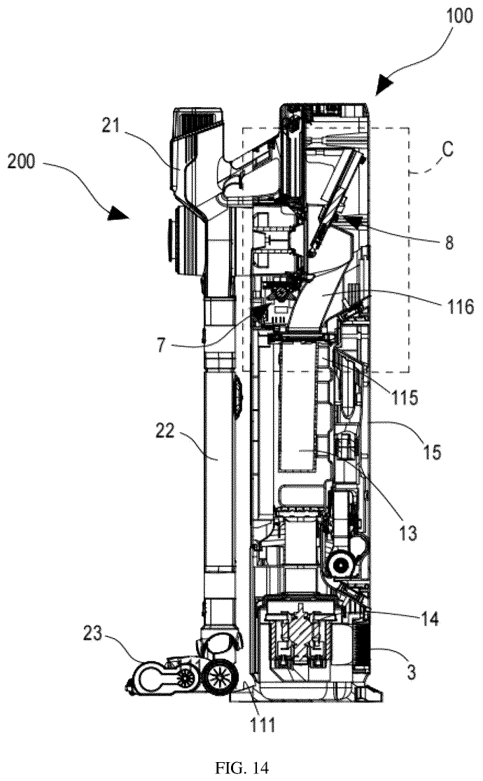

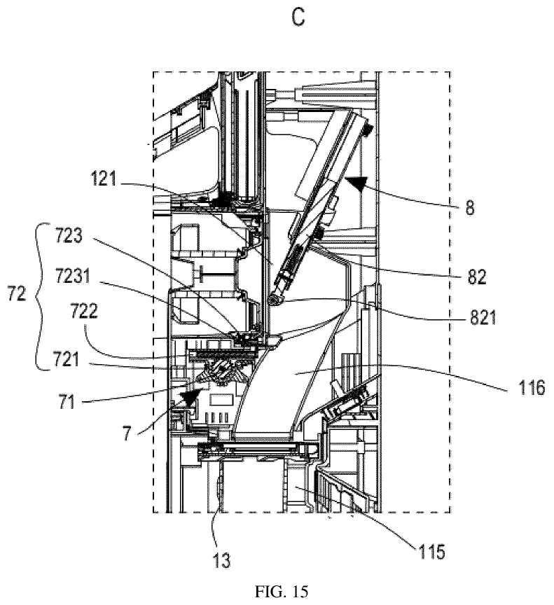

As shown in FIGS. 12, 13, 14 and 15, when the portable vacuum cleaner 200 is matched with the vacuum cleaner base station 100, the portable vacuum cleaner body 21 is docked at the docking seat 12, and the opening mechanism 7 is controlled to work, so that the dust cup bottom cover 212 of the portable vacuum cleaner body 21 can be opened, and the dust cup 211, the docking opening 121, the channel 116, and the dust collection bag 13 are fluidly connected in sequence. When the suction motor 14 is started, the dust in the dust cup 211 can be transferred to the dust collection bag 13 through the docking opening 121 and the channel 116, and the clean air flows through the suction motor 14 and the motor downstream filter 3, and is discharged to the outside through the exhaust ports 119. Among them, after opening the dust cup bottom cover 212, the opening mechanism 7 can be reset to its original position to prepare for the next task of opening the dust cup bottom cover 212; when the dust in the dust cup 211 is completely removed, the suction motor 14 is controlled to shut down, and then the closing mechanism 8 can be controlled to start working to achieve the conversion of the dust cup bottom cover 213 in the open position to the closed position; after the dust cup bottom cover 213 is switched to the closed position, the closing mechanism 8 can be reset to its original position to prepare for the next task of closing the dust cup bottom cover 212.

When the portable vacuum cleaner 200 is performing surface cleaning work, if it is necessary to use the vacuum head attachments stored in the sliding door 15, the sliding door 15 is slid outward to expose the required vacuum head attachments. The user can then remove the vacuum head attachment from the bracket so that it can be docked with the vacuum head of the portable vacuum cleaner body 21 or the hard vacuum wand 22 to perform the cleaning task.

When the vacuum cleaner base station 100 needs maintenance, the front door can be opened to replace or clean the dust collection bag 13; the rear door can be opened to replace or clean the motor downstream filter 3.

The vacuum cleaner base station 100 of the present application can automatically open or close the dust cup bottom cover 212 of the dust cup 211 through the arrangement of the opening mechanism 7 and the closing mechanism 8, so that after the portable vacuum cleaner 200 is docked on the vacuum cleaner base station 100, the dust in the dust cup 211 can be automatically transferred to the dust collection bag 13 of the vacuum cleaner base station 100, which can solve the problem that the dust in the dust cup of the traditional portable vacuum cleaner 200 needs to be manually cleaned frequently due to the small dust cup capacity, which is conducive to reducing the manual labor of the user and improving the convenience of using the portable vacuum cleaner. In addition, the vacuum head attachments can be stored inside the sliding door 15, and the vacuum cleaner base station 100 and the portable vacuum cleaner 200 are more concise as a whole.

Although the embodiments of the present application have been shown and described, it will be appreciated by those skilled in the art that various changes, modifications, substitutions and variations may be made to the embodiments without departing from the principles and spirit of the present application, and that the scope of the present application is defined by the claims and their equivalents.

1. A vacuum cleaner base station, which is suitable for docking a portable vacuum cleaner, the portable vacuum cleaner comprising a portable vacuum cleaner body, a vacuum wand, a floor brush and a plurality of vacuum head attachments, the portable vacuum cleaner body comprising a dust cup, a dust cup bottom cover switchable between an open position and a closed position, a vacuum motor and a rechargeable battery pack; the base station is characterized by comprising:
a housing, which can be supported on a horizontal plane and comprises a front wall, a first side wall and a second side wall opposite to each other, wherein an interior of the housing has a cavity;
a docking seat, located at an upper part of the housing and configured to hold at least a portion of the portable vacuum cleaner body, the at least a portion including the dust cup bottom cover, the docking seat having a docking opening for fluid communication with the dust cup when the dust cup bottom cover is in an open position, the docking opening being fluidly communicated with the cavity;
a dust collection bag removably disposed in the cavity;
a suction motor for generating an airflow from the docking opening to the dust collection bag; and
a sliding door, located at a rear portion of the housing and configured to be opened by sliding laterally outward; wherein an inner side of the sliding door defines a receiving space configured to receive at least a portion of the plurality of vacuum head attachments.

2. The vacuum cleaner base station according to claim 1, characterized in that
the sliding door includes a bracket located in the receiving space, and the bracket is configured to support the vacuum head attachments when the vacuum head attachments are located in the receiving space.

3. The vacuum cleaner base station according to claim 1, characterized in that
the sliding door includes a rear wall, a first extension wall extending forward from a side edge of the rear wall, and a second extension wall extending forward from another side edge of the rear wall, and the rear wall, the first extension wall and the second extension wall define the receiving space.

4. The vacuum cleaner base station according to claim 3, characterized in that
a handle for a user to grasp is arranged on the first extension wall and/or the rear wall.

5. The vacuum cleaner base station according to claim 3, characterized in that
when the sliding door is closed, the first side wall is butted against the first extension wall front to back, and the second side wall is butted against the second extension wall front to back.

6. The vacuum cleaner base station according to claim 3, characterized in that
a transverse cross-section of the sliding door is U-shaped.

7. The vacuum cleaner base station according to claim 1, characterized in that
the rear portion of the housing has a recessed portion; when the sliding door is closed, the sliding door covers the recessed portion.

8. The vacuum cleaner base station according to claim 1, characterized in that
at least one set of sliding mechanisms is arranged between the sliding door and the rear portion of the housing, and each of the sliding mechanisms includes a slide rail arranged on one of the sliding door and the rear portion of the housing and at least one roller arranged on the other of the sliding door and the rear of the housing, and the at least one roller can slide along the slide rail.

9. The vacuum cleaner base station according to claim 8, characterized in that
the slide rail is a two-section slide rail or a three-section slide rail.

10. The vacuum cleaner base station according to claim 8, characterized in that
two sliding mechanisms are provided between the sliding door and the rear portion of the housing, and the two sliding mechanisms are arranged one above and one below.

11. The vacuum cleaner base station according to claim 1, characterized by further comprising
a spare battery pack storage compartment, and the spare battery pack storage compartment is arranged on the upper part of the housing and located on a rear side of the docking seat.

12. The vacuum cleaner base station according to claim 11, characterized in that
the spare battery pack storage compartment has an upper opening, and a lift-up cover is provided at the upper opening.

13. The vacuum cleaner base station according to claim 1, characterized in that
a bottom of the housing has a base, and a front part of the base protrudes forward relative to the front wall.

14. The vacuum cleaner base station according to claim 1, characterized in that
the front wall includes a front door that can be opened and closed, and the dust collection bag is configured to be removable from the cavity when the front door is opened.

15. The vacuum cleaner base station according to claim 1, characterized in that
the portable vacuum cleaner body has a locking assembly for limiting the dust cup bottom cover in the closed position, and the locking assembly includes an operable unlocking component;
the vacuum cleaner base station further comprises: an opening mechanism, which is used to trigger the unlocking component when the portable vacuum cleaner body is docked with the docking seat, so that the dust cup bottom cover in the closed position is converted to the open position; and a closing mechanism, which is used to push the dust cup bottom cover in the open position into the closed position when the portable vacuum cleaner body is docked with the docking seat.

16. The vacuum cleaner base station according to claim 15, characterized in that
the opening mechanism comprises a first motor and a first transmission mechanism, the first transmission mechanism includes a gear that can be driven to rotate by an output shaft of the first motor, a rack meshing with the gear, and a moving component arranged in transmission connection with the rack, the moving component has an inclined surface inclined relative to a horizontal plane; when the portable vacuum cleaner body is docked with the docking seat, the inclined surface faces the unlocking component.

17. The vacuum cleaner base station according to claim 15, characterized in that
the closing mechanism comprises a second motor and a second transmission mechanism, the second transmission mechanism comprises a push rod that can be driven by an output shaft of the second motor to move along a straight line, and the straight line and the horizontal plane form an angle greater than or equal to 10° and less than or equal to 80°; when the portable vacuum cleaner body is docked with the docking seat, the end of the push rod faces the dust cup bottom cover.

18. The vacuum cleaner base station according to claim 1, characterized by further comprising
a sterilization component, which is arranged in the cavity.

19. The vacuum cleaner base station according to claim 1, characterized in that
the interior of the housing has a motor installation cavity located below the cavity, the suction motor is installed in the motor installation cavity, and the rear portion of the housing has exhaust ports connected to the motor installation cavity.

20. The vacuum cleaner base station according to claim 19, characterized in that
the rear portion of the housing has a rear cover that can be operated to open and close, the exhaust ports are arranged on the rear cover, and a motor downstream filter is arranged on an inner side of the rear cover.
